(19) United States
(12) Patent Application Publication
(10) Pub. No.: US 2020/0218295 A1
(43) Pub. Date: Jul. 9, 2020

(54) A DISINFECTION DEVICE FOR A VALVE

(71) Applicant: Reliance Worldwide Corporation (Aust.) Pty. Ltd., Eagle Farm (AU)

(72) Inventors: Gary HAY, Eagle Farm (AU); David Peter FORRESTAL, Eagle Farm (AU); Jake HARDT, Eagle Farm (AU)

(73) Assignee: Reliance Worldwide Corporation (Aust.) Pty. Ltd., Eagle Farm (AU)

(21) Appl. No.: 16/628,553

(22) PCT Filed: Jul. 5, 2018
(86) PCT No.: PCT/AU2018/050697

§ 371 Date: Jan. 3, 2020

(30) Foreign Application Priority Data
Jul. 6, 2017 (AU) 2017902653
Mar. 2, 2018 (AU) 2018900682

(51) Int. Cl. G05D 23/13

(52) U.S. Cl. CPC G05D 23/1346

(57) ABSTRACT

A disinfection device for a valve, the disinfection device including: a mobile member having an outer portion including a camming surface configured to engage with an activation member such that rotation of the activation member relative to the camming surface, about an axis, moves the mobile member in the axial direction, wherein the mobile member is associated with an adjusting device of the valve such that movement of the mobile member in the axial direction moves at least part of the adjusting device to allow adjustment of a predetermined outlet temperature of the valve.

### FIELD OF THE INVENTION

The invention relates to a disinfection device for a valve. In particular, the invention relates, but is not limited, to a disinfection device for a thermostatic mixing valve or thermostatic cartridge. The invention also relates to a valve incorporating a disinfection device, as well as a tool and a method for operating a disinfection device.

### BACKGROUND TO THE INVENTION

Reference to background art herein is not to be construed as an admission that such art constitutes common general knowledge in Australia or elsewhere.

Regulating the storage temperature of hot water above 60° C. is becoming an increasingly common practice. This assists in, amongst other things, removing possible breeding grounds for Legionella. The downside of regulating hot water above 60° C. is the increased risk of scalding when the hot water is delivered from a tap. On this basis, safety regulations may require that the predetermined outlet temperature of water in certain buildings and dwellings be controlled to a safe outlet temperature.

A solution to assist in avoiding potential scalding is the use of a thermostatic mixing valve. A thermostatic mixing valve mixes hot water with cold water to deliver a safe outlet temperature. However, as it would be appreciated, reducing the outlet temperature of the mixed water to a safe temperature (e.g. 50° C. or less) increases the risk of Legionella and the alike. Allied to these problems, valves comprising thermostatic cartridges, typically used in taps, require thermal disinfection.

It is therefore useful to have the ability to temporarily disable the operation of a thermostatic device in a valve to allow it and its plumbing system downstream to undergo localised disinfection by passing hot water therethrough. Ideally, an operator should also be unable to leave this temporary disablement operation unattended, which could potentially put users at risk of scalding. Furthermore, for safety reasons, along with convenience, it is preferable that the thermostatic mixing device is readily returned to its predetermined outlet temperature after it has been thermally disinfected.

### SUMMARY OF INVENTION

In one form, although not necessarily the only or broadest form, the invention resides in a disinfection device for a valve, the disinfection device including:

a mobile member having an outer portion including a camming surface configured to engage with an activation member such that rotation of the activation member relative to the camming surface, about an axis, moves the mobile member in the axial direction,

wherein the mobile member is associated with an adjusting device of the valve such that movement of the mobile member in the axial direction moves at least part of the adjusting device to allow adjustment of a predetermined outlet temperature of the valve.

By separating the rotational movement of the activation member from the (vertical) movement of the mobile member, in the axial direction, the mobile member can raise at least part of the adjusting device of the valve in order to change the predetermined outlet temperature of the valve. This allows thermal disinfection of the valve whilst readily being able to return the valve to its (safe) predetermined outlet temperature setting. In this regard, this saves time as if the predetermined outlet temperature of the valve remained altered after thermal disinfection, the valve would have to be recommissioned according to strict requirements (often specified by standards). These strict requirements frequently include monitoring the inlet pressures of the valve and taking other measurements in order to ensure that the predetermined outlet temperature is set appropriately.

In an embodiment, the camming surface extends in a diagonal manner around at least part of the mobile member.

In an embodiment, the camming surface is formed from one or more outermost surfaces of the mobile member.

In an embodiment, the camming surface includes two camming surfaces. In an embodiment, the camming surfaces are mirrored either side of the moving member.

In an embodiment, the mobile member is configured to be lifted away from a thermostatic element of the valve whilst the activation member is rotated about the axis.

In an embodiment, the mobile member is operable by application of a tool. In an embodiment, the tool is removable from the disinfection device.

In an embodiment, the outer portion of the mobile member includes a retaining surface to assist in retaining a part of the tool. In an embodiment, the retaining surface is in the form of a projection, slot and/or groove. In an embodiment, the tool cannot be removed from the mobile member until the predetermined outlet temperature of the valve is returned.

In an embodiment, the mobile member includes a retaining portion that assists in setting a travel limit for the mobile member.

In an embodiment, the mobile member includes an inner portion. In an embodiment, the inner portion of the mobile member is hollow. In an embodiment, the hollow inner portion of the mobile member is configured to receive at least an upper portion of the adjusting device therethrough.

In an embodiment, the activation member rotates about the axis whilst remaining substantially steadfast in the axial direction.

In an embodiment, the activation member engages the camming surface of the mobile member with a corresponding camming surface.

In an embodiment, the camming surface of the activation member is formed from an inner surface thereof to engage with the mobile member.

In an embodiment, at least one of the camming surfaces of the mobile member or activation member include a projection. In an embodiment, the projection extends in a diagonal manner. As outlined further below, the projection (i.e. a tab) assists in moving the mobile member in the axial direction.

In an embodiment, at least one of the camming surfaces of the mobile member or activation member includes a slot and/or groove.

In an embodiment, the mobile member is configured to be threadably connected to the adjusting device. In a further form, the adjusting device extends above the mobile member to provide a force path thereto. In an embodiment, the force path is substantially in the axial direction.

In an embodiment, the activation member includes a device activation member and/or a tool activation member. In an embodiment, the tool activation member is associated with the tool. In an embodiment, the device activation member is associated with the disinfection device.

In an embodiment, the device activation member includes an interface portion. In an embodiment, the interface portion is configured to engage with a tool that provides a rotational force to the interface portion. In an embodiment, the interface portion includes a plurality of teeth that are arranged annularly around the activation member.

In an embodiment, the disinfection device includes a support member. In an embodiment, the support member includes an aperture to support the device activation member and/or the mobile member therein.

In an embodiment, a fastener assists in retaining the device activation member in the support member.

In an embodiment, the support member includes a coupling portion configured to connect to the tool. In an embodiment, the coupling portion is in the form of a thread. In an embodiment, the support member includes one or more interfacing portions that, when engaged, assist in preventing a portion of the tool from rotating.

In another form, the invention resides in a disinfection device for a valve, the disinfection device including:

a support member configured to engage with a body of the valve;

an activation member supported by the support member, the activation member configured to rotate relative to the support member about an axis; and

a mobile member configured to engage with the activation member such that rotation of the activation member moves the mobile member in the axial direction,

wherein the mobile member is associated with an adjusting device of the valve such that movement of the mobile member moves at least part of the adjusting device to adjust a predetermined outlet temperature of the valve.

In an embodiment, the disinfection device is herein as described.

In another form, the invention resides in a mixing valve mechanism including:

an adjustment part affording selective adjustment of a setpoint temperature from a normal use configuration to a disinfection configuration by rotation of the adjustment part about a longitudinal axis of the mixing valve mechanism, the disinfection configuration allowing hot water disinfection, the adjustment part operable by application of a removable rotational tool,

whereby engagement of the tool to the mechanism in a first position and rotation of the tool about the longitudinal axis adjusts the adjustment part into the disinfection configuration, the engagement being such that the tool cannot be removed from the mechanism until it has been rotated back towards the first position.

In another form, the invention resides in a tool for operating the above defined disinfection device, the tool including:

an activation part configured to assist in rotating a camming surface of the activation member in order to move the mobile member of the disinfection device, the mobile member being associated with the adjusting device of the valve such that movement of the mobile member moves at least part of the adjusting device to allow adjustment of the predetermined outlet temperature of the valve; and

a retaining part having a retaining surface configured to assist in preventing the tool from being removed from the disinfection device whilst the predetermined outlet temperature of the valve is adjusted.

In an embodiment, the disinfection device is herein as described.

In an embodiment, the activation part is adapted to move over the mobile member.

In an embodiment, the activation part includes the activation member to form a tool activation member.

In an embodiment, the tool activation member includes a tool camming surface configured to engage with the camming surface of the lifting member.

In an embodiment, the tool camming surface extends in a diagonal manner. In an embodiment, the tool camming surface is in the form of a projection, slot and/or groove.

In a further embodiment, the activation part engages with the activation member to provide rotation thereto. In an embodiment, in this further form, the activation part includes one or more protrusions that are configured to engage with the activation member.

In an embodiment, the tool includes an engagement device. In an embodiment, the engagement device is configured to rotate relative to the activation part.

In an embodiment, the engagement device includes an engagement portion configured to releasably engage with the valve. In an embodiment, the engagement portion includes one or more protrusions.

In an embodiment, in response to rotating the activation part from an initial position to adjust the predetermined outlet temperature of the valve, the activation part is biased to return to the initial position when the tool is released. In an embodiment, a spring is connected between the activation part and the engagement device.

In an embodiment, the retaining part extends across an inner surface of the activation part or the engagement portion.

In an embodiment, the retaining part is in the form of a protrusion, groove and/or slot.

In an embodiment, in order to assist in preventing the tool from being removed from the disinfection device whilst the predetermined outlet temperature of the valve is adjusted, the retaining part is configured to engage with a retaining surface of the valve. In an embodiment, the surface of the valve includes part of the mobile member.

In an embodiment, a drive member is connected to the activation part and/or the engagement device. In an embodiment, the drive member includes one or more movement guides. In an embodiment, the one or more movement guides assist in restraining the rotation of the engagement device.

In an embodiment, the tool includes a balancing device. In an embodiment, the balancing device assists in balancing forces on the mobile member and/or the adjusting device when they are moved to adjust the predetermined outlet temperature of the valve. In an embodiment, the balancing device includes at least part of the engagement device.

In an embodiment, the balancing device provides a biasing force on the adjusting device to reduce the rotational force required to rotate the adjusting member with the activation part. In an embodiment, the biasing force is applied with a spring.

In an embodiment, the tool includes a holding device. In an embodiment, the holding device assists in releasably connecting the tool to the disinfection device. In an embodiment, the holding device includes a threaded portion that releasably engages with the support member of the disinfection device.

In another form, the invention resides in a tool for operating the above defined disinfection device, the tool including:

an activation part configured to assist in rotating a camming surface of the activation member in order to move the mobile member of the disinfection device, the mobile member being associated with the adjusting device of the valve such that movement of the mobile member moves at least part of the adjusting device to allow adjustment of a predetermined outlet temperature of the valve; and

wherein in response to rotating the activation part from an initial position to adjust the predetermined outlet temperature of the valve, the activation part is biased to return to the initial position when the activation part is released.

In an embodiment, the tool is herein as described.

In another form, the invention resides in a valve including:

a body with two or more inlets and an outlet;

an adjusting device associated with the body, the adjusting device providing a stop;

a thermostatic element being configured to assist with moving a piston connected thereto in response to engaging with the stop, the piston being configured to regulate the flow of fluid between the inlets and the outlet; and

a disinfection device as defined above.

In an embodiment, the disinfection device is herein as described.

In an embodiment, the adjusting device includes a thread to set the predetermined outlet temperature of the valve.

In an embodiment, the adjusting device includes a housing. In an embodiment, the housing is in the form of a spindle.

In an embodiment, the mobile member is releasably connected to the adjusting device. In a further form, the mobile adjusting device extends over the mobile member to provide a force path thereto.

In an embodiment, the adjusting device includes a limit member. In an embodiment, the mobile member is configured to move the limit member.

In an embodiment, the limit member is configured to engage with a barrier to limit the rotation of the adjusting device.

In an embodiment, the mobile member is configured to move the limit member in the axial direction in order to avoid the barrier and allow the stop to move further in the axial direction.

In an embodiment, the connection of the adjusting device to the mobile member sets a position of the stop, relative to the element, that determines the predetermined outlet temperature.

In a further embodiment, the adjusting device includes two adjusting members that are threadingly connected together to define a position of the stop, relative to the element, that determines the predetermined temperature from the outlet.

In another form the invention resides in a method of operating a disinfection device for a valve, the method including the steps of:

engaging an engagement device of a tool with at least part of the disinfection device;

rotating an activation member about an axis with the assistance of a drive member, the activation member being engaged with a mobile member such that rotation of the activation member moves the mobile member in the axial direction,

wherein the mobile member is associated with an adjusting device of the valve such that movement of the mobile member moves at least part of the adjusting device to allow adjustment of a predetermined outlet temperature of the valve.

In an embodiment, the step of engaging the engagement device of a tool with at least part of the disinfection device includes aligning a camming surface of the tool with a camming surface of the mobile member.

In an embodiment, the step of engaging the engagement device of a tool with at least part of the disinfection device includes engaging one or more protrusions of the tool with at least part of the valve.

In an embodiment, the step of engaging the engagement device of a tool with at least part of the disinfection device further includes releasably connecting the tool to the disinfection device. In an embodiment, the step of releasably connecting the tool to the disinfection device includes fastening the tool to the disinfection device.

In an embodiment, the step of rotating the activation member about the axis includes biasing a spring in order to return the tool to an initial position when the tool is released.

In an embodiment, the step of rotating the activation member about the axis includes rotating the drive member until a movement guide of the tool reaches an end.

As will be understood from this specification, the invention provides a disinfection device for a valve which addresses at least in part one or more of the disadvantages or problems noted above or at least provides a useful alternative.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates an exploded view of a valve (i.e. a thermostatic valve) including a disinfection device, according to an embodiment of the invention;

FIG. 2 illustrates a first cross-sectional view of the valve shown in FIG. 1;

FIG. 3 illustrates a second cross-section view of the valve shown in FIG. 1;

FIG. 4 illustrates an exploded view of a tool for operating the disinfection device shown in FIG. 1, according to an embodiment of the invention;

FIG. 5 illustrates a cross-section view of the tool shown in FIG. 4;

FIG. 6 illustrates a first position of the tool, shown in FIG. 4, when engaging the disinfection device shown in FIG. 1;

FIG. 7 illustrates a second position of the tool, shown in FIG. 4, when operating the disinfection device shown in FIG. 1;

FIG. 8 illustrates an exploded view of a valve (i.e. a thermostatic cartridge) including a disinfection device, according to a further embodiment of the invention;

FIG. 9 illustrates a cross-section view of the valve shown in FIG. 8;

FIG. 10 illustrates an exploded view of a tool for operating the disinfection device shown in FIG. 8, according to a further embodiment of the invention;

FIG. 11 illustrates a cross-section view of the tool shown in FIG. 10;

FIG. 12 illustrates a first position of the tool, shown in FIG. 10, when engaging the disinfection device shown in FIG. 8;

FIG. 13 illustrates a second position of the tool, shown in FIG. 10, when operating the disinfection device shown in FIG. 8;

FIG. 14 illustrates a perspective view of a valve (i.e. a thermostatic cartridge) including a disinfection device, according to another embodiment of the invention; and

FIG. 15 illustrates a perspective view of a mobile member, shown in FIG. 14, according to a further embodiment of the invention;

FIG. 16 illustrates a perspective view of a further mobile member according to another embodiment of the invention;

FIG. 17 illustrates a perspective view of a first body of a valve according to another embodiment of the invention; and

FIG. 18 illustrates a cross-section view of a tool according to another embodiment of the invention.

### DETAILED DESCRIPTION OF THE DRAWINGS

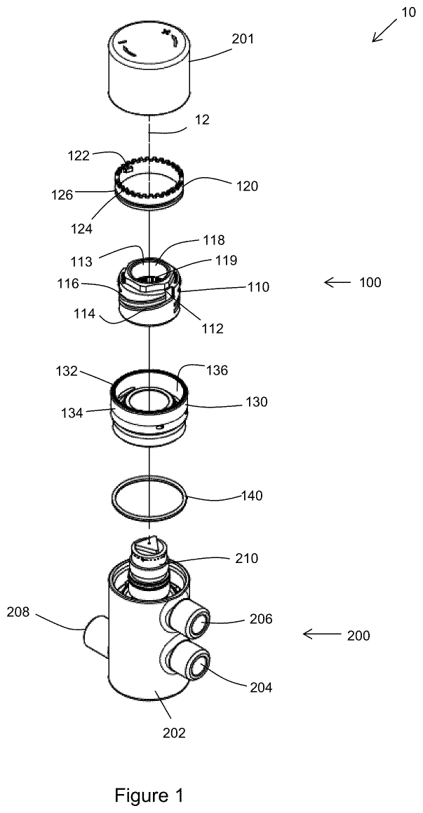

FIG. 1 illustrates an exploded view of a valve 10 in the form of a thermostatic valve. The valve 10 includes a disinfection device 100 supported by a body 200. An axis 12 extends along the valve 10 and the disinfection device 100.

In this embodiment, the disinfection device 100 includes a mobile member 110, an activation member in the form of device activation member 120, a support member 130 and a sealing member 140.

The mobile member 110 includes an outer portion 112 and an inner portion 113. Along the outer portion 112, either side of the mobile member 110, is a camming surface 114. Similarly, separate retaining surfaces 116 extend along the outer portion 112 of the mobile member 110 above the camming surfaces 114. The camming and retaining surfaces 114, 116 are in the form of slots in this embodiment. It will be appreciate that in further embodiments the camming and retaining surfaces 114, 116 may take a number of different shapes and extend partway or through the mobile member 110.

The camming and retaining surfaces 114, 116 are joined at one end with section that extends in a substantially parallel manner with the axis 12. Each of the camming and retaining surfaces 114, 116 extend approximately halfway around the mobile member 110. Furthermore, the camming and retaining surfaces 114, 116 extend in a helical manner around the mobile member 110. That is, the camming and retaining surfaces 114, 116 extend in a diagonal manner, along an outermost surface of the mobile member 110, relative to the top and/or bottom of the mobile member 110. The camming and retaining surfaces 114, 116 extend substantially parallel to each other in this embodiment.

The mobile member 110 also includes a fastening portion 118 on the inner portion 113. As outlined further below, the fastening portion 118 is configured to connect to an adjusting device 210 in order to (temporarily) adjust a predetermined outlet temperature of the valve 10. The mobile member 110 also includes a plurality of guiding members 119 that assist with its movement along the support member 130. The guiding members 119 include a plurality of ridges.

The device activation member 120 is substantially cylindrical in this embodiment and includes a hollow portion therethrough. The device activation member 120 includes a device camming surface 122. The device camming surface 122 in this embodiment includes two projections (i.e. tabs), located either side of the device activation member 120. The projections are configured to engage with the camming surfaces 114 of the mobile member 110. The projections extend diagonally across an inner surface of the device activation member 120.

At an upper portion, the device activation member 120 includes an interface portion 124. The interface portion 124 includes a plurality of protrusions that are configured to engage with a tool, as further outlined below. In addition, the device activation member 120 includes a recess portion 126 that receives a fastener in the form of a split pin 150. The split pin 150 assists in retaining the device activation member 120 in the support member 130 and allows the device activation member 120 to rotate about the axis 12. In this regard, it will be appreciated that as the device activation member 120 is retained by the split pin 150, the device activation member 120 is restricted from moving along the axis 12 but is able to rotate thereabout.

The support member 130 is substantially circular. The support member 130 includes an interfacing portion 132 having a plurality of teeth. The interfacing portion 132, as outlined further below, is configured to engage with a tool 300 to assist in preventing relative rotation therebetween. The support member 130 also includes a releasable connection in the form of thread 134. The thread 134 assists in connecting the tool 300 to the valve 10.

The support member 130 supports the mobile member 110 and the device activation member 120. In particular, the support member 130 includes a groove 136 to receive the mobile member 110 and the device activation member 120. The groove 136 is in the form of a channel. The mobile member 110 is located to one side of the channel whilst the device activation member 120 is located to another side of the channel. The support member 130 is sealingly connected to the body 200 via the sealing member 140. As outlined further below, a lower portion of the support member 130 provides a seat for assisting in the regulation of fluid flow through the valve 10.

The body 200 of the valve 10 includes a cap 201 and a main body 202. The cap 201 is releasably connected to the main body 202. The main body 202 includes a first inlet 204, a second inlet 206 and an outlet 208. It would be appreciated that the first inlet 204 and the second inlet 206 are separately connected to either hot or cold fluid sources. The body 200 is substantially hollow and, as outlined further below, the body 200 supports other components of the valve 10 therein.

The valve 10 further includes an adjusting device 210. The adjusting device 210 is located and supported within the body 200. The adjusting device 210 includes a housing in the form of spindle 212. The spindle 212 is substantially hollow with one closed end. The middle of the adjusting device 210 is substantially co-located with the axis 12. The adjusting device 210 is configured to releasably engage with the mobile member 110. In particular, at an upper portion of the spindle 212, the mobile member 110 is threadingly connected to the spindle 212. In this regard, the adjusting device 210 may move along the axis 12 when it is fastened along the mobile member 110. As outlined further below, the position of at least part of the adjusting device 210 assists in determining a (safe) predetermined outlet temperature. A sealing member 142 provides a seal between the spindle 212 and the support member 130.

The adjusting device 210 includes a spring 214. The spring 214 is located within the hollow of the spindle 212. The spring 214 abuts the closed end of the spindle 212 and biases a stop 216 towards an open end of the spindle 212. The stop 216 is retained within the spindle 212 by a circlip 218.

A thermostatic element 220 is situated below the stop 216. As would be appreciated, the thermostatic element 220 turns thermal energy into mechanical energy in response to changes in temperature. The thermostatic element 220 is connected to a piston 230. The piston 230 is substantially cylindrical in this embodiment (but it will be appreciated that other shapes may be used). The piston 230 is located adjacent to a separator 240. The separator 240 is configured to keep fluid flow through the inlets 204, 206 separate until it passes the piston 230. The element 220 is also connected to a further spring 250. The further spring 250 biases the element 220 towards the stop 216.

As the thermostatic element 220 provides movement in response to changes in temperature, the piston 230 is configured to move with the thermostatic element 220. In particular, with the assistance of the thermostatic element 220, the piston 230 is configured to move between the seat on the lower portion of the support member 130 and a seat 242 of the separator 240. As the piston 230 moves to engage with each seat, flow through respective inlets 204, 206 is restricted in order to achieve a (safe) predetermined outlet temperature through the outlet 208.

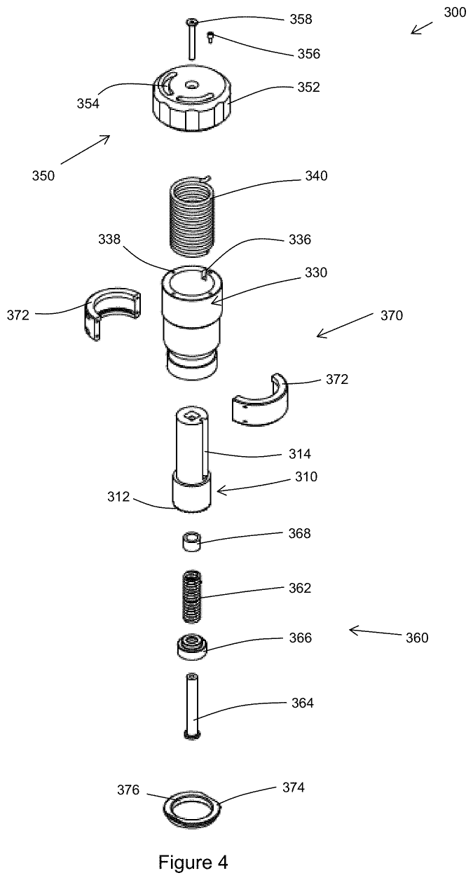

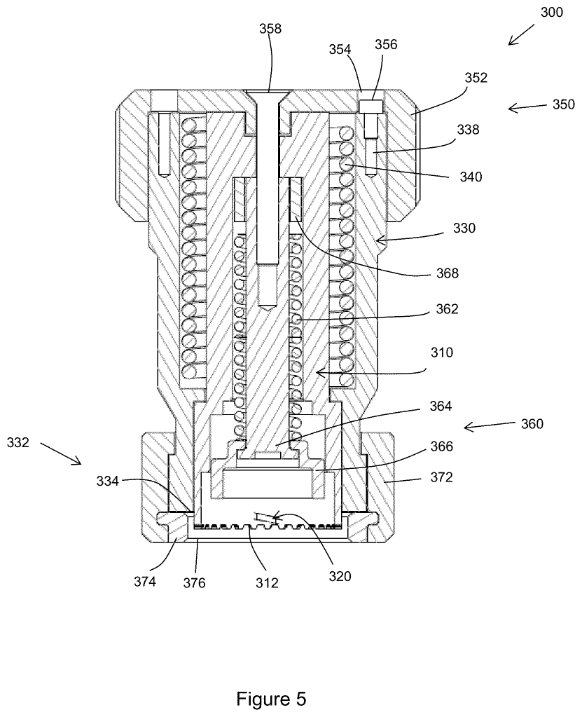

FIG. 4 illustrates an exploded view of a tool 300 for operating the disinfection device 100 shown in FIG. 1. The tool 300 includes an activation part 310. The activation part 310 is substantially hollow in this embodiment. The activation part 310 includes a plurality of protrusions 312 in the form of teeth. The protrusions 312 are configured to engage with the interface portion 124 of the device activation member 120 to provide a rotational force thereto. In this embodiment, the hollow portion of the activation part 310 also includes retaining parts 320 on either side. The retaining parts 320 extend diagonally across the hollow portion of the activation part 310 (i.e. the retaining parts 320 are not perpendicular to a longitudinal axis of the activation part 310). The retaining parts 320 are located above the protrusions 312.

The tool 300 further includes an engagement device 330. The engagement device 330 is substantially hollow and has one or more seats therein to receive other components of the tool 300. The engagement device 330 includes an engagement portion 332 in this embodiment having a plurality of protrusions 334. The protrusions 334 are configured to engage with the teeth of the interfacing portion 132. The engagement device 330 includes a retaining portion 336 that assists in retaining the spring 340. In particular, a tab of the spring 340 is inserted into the retaining portion 336 in order to retain a portion of the spring 340 to the engagement device 330 whilst the spring 340 is torqued. The engagement device 330 also includes one or more apertures 338 to receive a guiding member 356 therein.

A drive member 350 including a handgrip 352 is located above the engagement device 330. The handgrip 352 includes a movement guide 354. The movement guide 354 is in the form of a slot in this embodiment. A bridge extends across the slot for support. The movement guide 354 is configured to receive a guiding member 356. The engagement between the guiding member 356 and the movement guide 354 restricts the rotation of the drive member 350 to approximately 180 degrees. In this regard, it will be appreciated that the guiding member 356 moves under the bridge supporting the slot.

A fastener 358 extends through the drive member 350 to connect to the activation part 310 and a balancing device 360. A non-circular interface is provided between the drive member 350 and the activation part 310. In this regard, when the drive member 350 is rotated, the activation part 310 and at least part of the balancing device 360 are also rotated. In addition, the activation part 310 includes an aperture 314 to receive a portion of the spring 340 therein. Accordingly, in response to turning the activation part 310 with the drive member 350, the spring 340 is configured to bias the activation part 310 to its initial position before rotation.

In this embodiment, the balancing device 360 includes a spring 362, a shaft 364 and a balancing member 366. The spring 362 is received within the activation part 310 and is positioned around the shaft 364. A spacer 368 is positioned above one end of the spring 362. The spring 362 biases the balancing member 366 towards a lower end of the shaft 364. The shaft 364 includes a flange portion to assist in retaining the balancing member 366 thereon. The balancing member 366 may move up along the shaft 364 under the bias of the spring 362.

In addition, the tool 300 also includes a holding device 370. The holding device 370 includes holding members 372 and a fastening portion in the form of nut 374. The nut 374 includes a thread 376. The holding members 372 connect around the engagement device 330 and retain the nut 374 therein. The holding member 372 are configured to rotate about the engagement device 330 with the nut 374 retained therein.

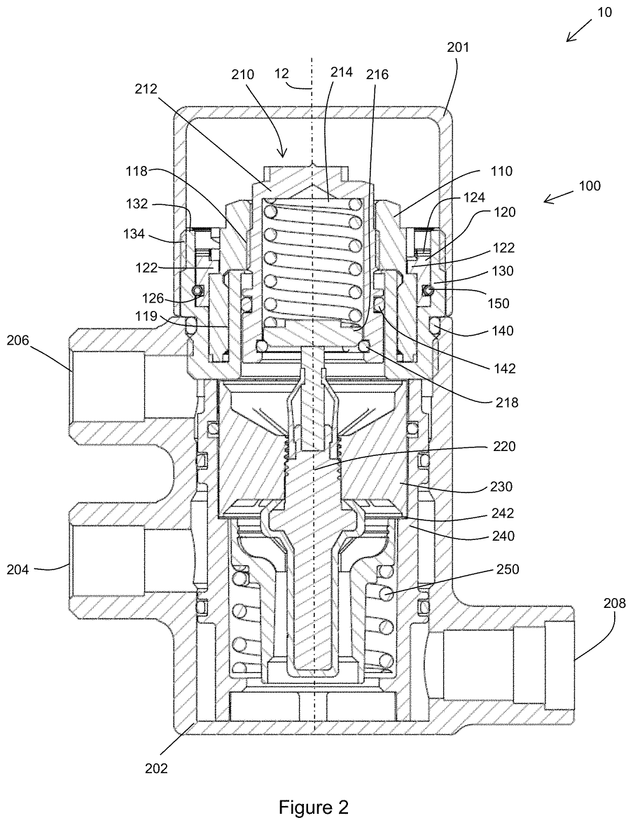

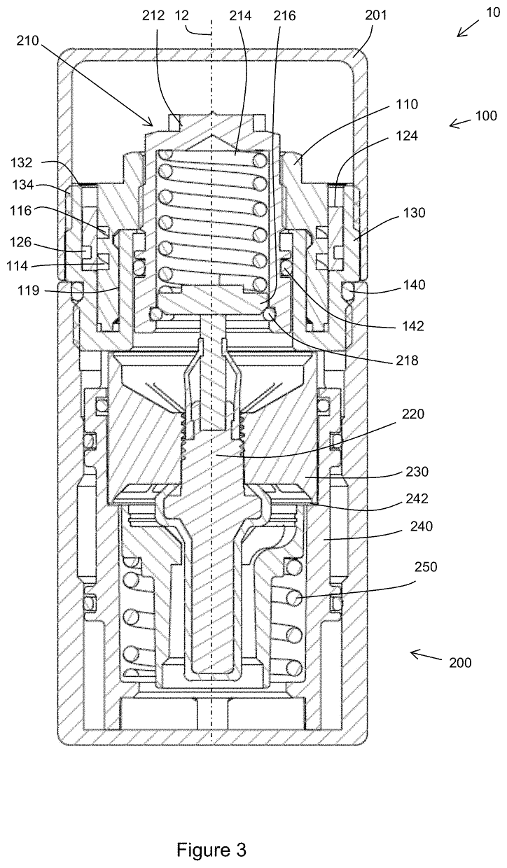

To set the predetermined outlet temperature, the spindle 212 of the adjusting device 210, as shown in FIGS. 2 and 3, is rotated along the mobile member 110 to define an initial distance between the stop 216 and the element 220. It will be appreciated that the initial distance between the stop 216 and the element 220 assists in defining the predetermined outlet temperature as it provides a reference point for the engagement between the stop 216 and the element 220, along with the associated movement of the piston 230, to regulate the flow of fluid through the inlets 204, 206. In this regard, as the adjusting device 210 is moved downward along the axis 12 in this embodiment, the predetermined outlet temperature is set lower. As the adjusting device is moved upward along the axis 12, the predetermined outlet temperature is set higher. Once the predetermined outlet temperature is set at a safe level, the valve 10 may begin normal operation where relatively hot and cold fluid is regulated therethrough to the outlet 208.

When the valve 10 is required to be thermally disinfected, the tool 300 is operated with the disinfection device 100 in the following manner. Firstly, the cap 201 (if present) is removed from the main body 202. Following this, the retaining parts 320 of the tool 300 are aligned with the upper portion of the retaining surfaces 116 as the tool 300 is moved thereover. With the tool 300 resting on the disinfecting device 100, the holding device 370 is rotated in a manner to allow the thread 376 to connect to the thread 134 of the support member 130. As the threads 134, 376 are tightened, the protrusions of the interface portion 124 are engaged with the protrusions 312 of the tool 300. Moreover, the protrusions 334 of the engagement device 330 further compress onto the teeth of the interfacing portion 132 in order to prevent relative rotation between the engagement device 330 and support member 130.

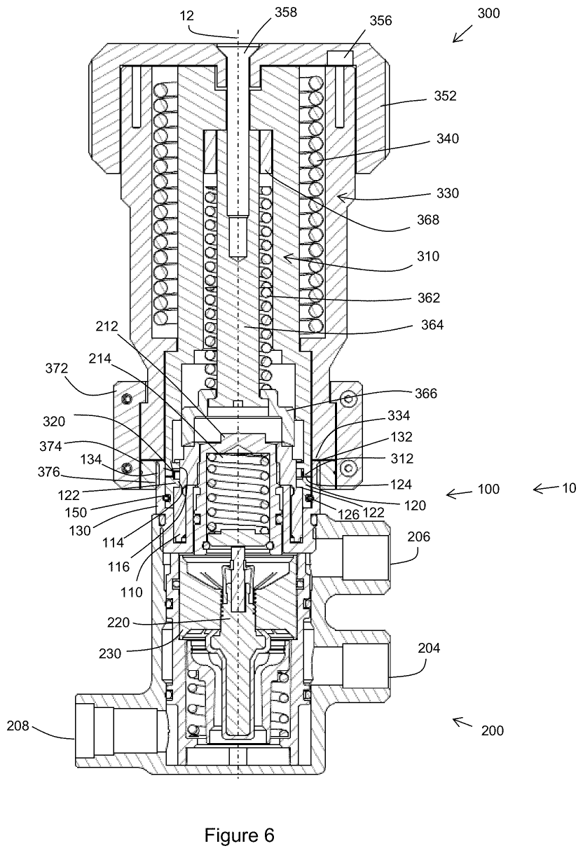

Before activating the disinfection device 100, the engagement between the disinfection device 100 and tool 300 is shown FIG. 6. As evident from this figure, the device camming surfaces 122 of the device activation member 120 are aligned with the camming surfaces 114 of the mobile member 110. Similarly, the retaining parts 320 of the tool 300 are aligned with the retaining surfaces 116 of the mobile member 110. The balancing member 366 is also resting between the flange portion of the shaft 364 and the mobile member 110.

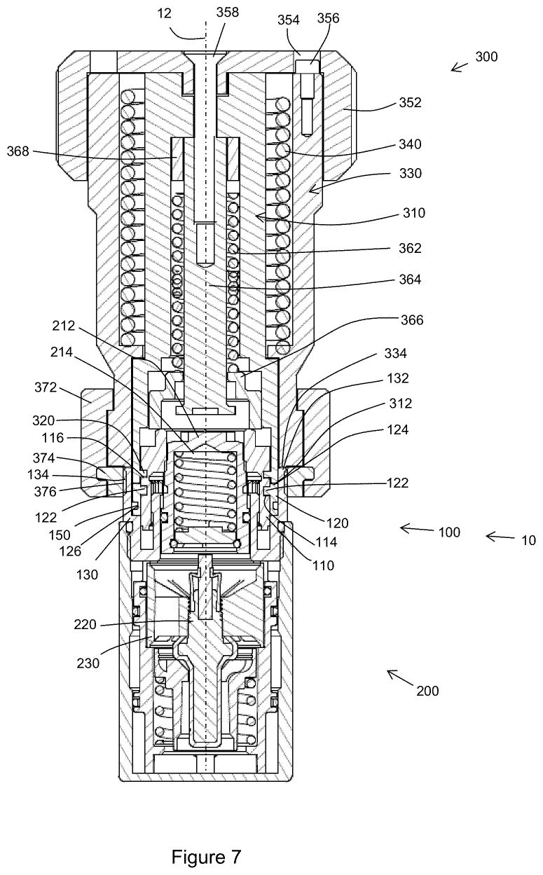

FIG. 7 illustrates a second position of the tool 300 where the tool 300 is operating the disinfection device 100. In this position, an operator has rotated the drive member 350, about the axis 12, approximately 180 degrees. As outlined above, in this embodiment, rotation of the drive member 350 is restricted to approximately 180 degrees when the guiding member 356 engages an end of the movement guide 354. As some further clarification on this, depending on the initial setting (and therefore height) of adjusting device 210, there may be less than 180 degrees of movement required before the adjustment device 210 reaches its maximum travel and/or the disinfection temperature position.

As the drive member 350 is rotated from the first position shown in FIG. 6 to the second position shown in FIG. 7, the activation part 310 rotates the device activation member 120 about the axis 12. As a result, the device camming surfaces 122 move along the camming surfaces 114 of the mobile member 110. Due to the helical shape of the camming surfaces 114, movement of the device camming surfaces 122 (i.e. the tabs) along the camming surfaces 114 results in the mobile member 110 moving in a vertical direction along the axis 12. That is, the mobile member 110 moves in the axial direction whilst the activation member 120 rotates relative to the camming surfaces 114. On this basis, as the mobile member 110 is connected to the adjusting device 210, the adjusting device 210 is also moved in a vertical direction along the axis 12. This shifts the stop 216 away from the element 220. This raises the temperature of the fluid leaving the outlet 208 as the element 220 does not engage with the stop 216 in a manner that shifts the piston 230 to restrict the flow of hot fluid through the valve 10. Accordingly, the valve 10 undergoes thermal disinfection.

With the above in mind, as the device camming surfaces 122 move along the camming surfaces 114 of the mobile member 110, it will also be appreciated that the retaining parts 320 of the tool 300 move along the retaining surfaces 116 of the mobile member 110. This assists in preventing the tool 300 being removed from the disinfection device 100 whilst the valve 10 is undergoing thermal disinfection. In order to remove the tool 300 from the valve 10, it will be appreciated that, in addition to releasing the threads 134, 376, the tool 300 needs to be rotated back to its initial position in order to allow the retaining parts 320 to move upward along the grooves of the mobile member 110.

To assist with balancing the force on the mobile member 110 and/or adjusting device 210 as it is raised along the axis 12, the mobile member 110 engages with the balancing member 366. The spring 362 biases the balancing member 366 towards the mobile member 110 in order to balance the pressure of the fluid in the valve 10. This is evident from the position of the balancing member 366 in FIG. 7 in comparison to FIG. 6. This assists in reducing the rotational force an operator needs to apply to the disinfection device 100, and also reduces the required strength of the spring 340 in the tool 300.

In addition, as the drive member 350 is rotated, it will be appreciated that the spring 340 is torqued between the activation part 310 and the engagement device 330. Accordingly, upon releasing the drive member 350, the spring 340 biases the activation part 310 back to its initial position before it was rotated. With the activation part 310 in its initial position, it will be appreciated that the mobile member 110 and the adjusting device 210 move back down along the axis 12 and the (safe) predetermined outlet temperature is returned. This ensures that an operator is unable to leave the valve 10 unattended in a thermal disinfection mode, potentially creating an unsafe condition where a user could be scalded downstream.

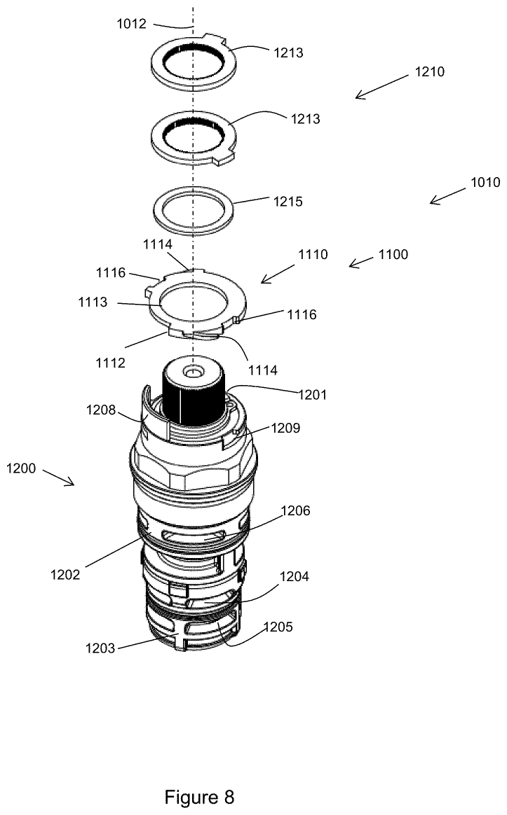

FIG. 8 illustrates an exploded view of a valve 1010, according to a further embodiment of the invention. As will be appreciated by a person skilled in the art, the valve 1010 in FIG. 8 is in the form of a thermostatic cartridge. Thermostatic cartridges are normally loaded into further bodies (i.e. a tap body) to assist with regulating with the flow of fluid.

The valve 1010 includes a disinfection device 1100 having a mobile member 1110. As evident from FIG. 8, the mobile member 1110 has a lower profile compared to the mobile member 110. In addition, the outer portion 1112 of the mobile member 1110 includes a tab having camming surfaces 1114. The camming surfaces 1114 are substantially in the form of a ramp that extends in a diagonal manner relative to the flat upper and/or lower surfaces of the mobile member 1110. The camming surfaces 1114 include curved surfaces.

Adjacent each camming surface 1114 is guiding surfaces 1116. The guiding surfaces 1116 in this embodiment each form a vertical slot in the outer portion 1112 of the mobile member 1110. As outlined further below, the guiding surfaces 1116 assist in guiding a tool 1300 into a bayonet mount that retains the tool during thermal disinfection. Separately, the inner portion 1113 of the mobile member 1110 is cylindrical in this embodiment and configured to receive at least part of the adjusting device 1210 therethrough.

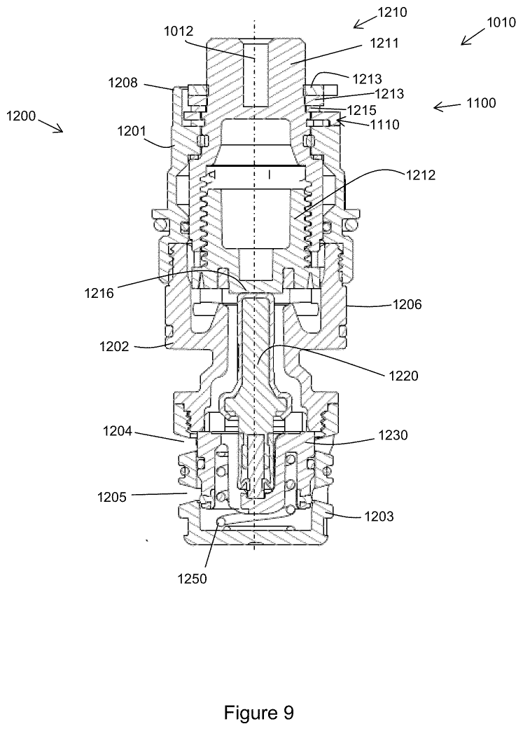

As shown further in FIG. 9, the valve 1010 includes a body 1200 having a first body 1201, a second body 1202 and a third body 1203. The bodies 1201, 1202, 1203 are threaded together. The third body 1203 includes a first inlet 1204 and a second inlet 1205. The second body includes an outlet 1206. The first body 1201 includes a barrier 1208 at an upper portion thereof. The barrier 1208 is in the form of a cylindrical tab in this embodiment. In addition, the first body 1201 includes a retaining surface 1209 substantially in the form of a slot. The slot extends in a substantially horizontal manner. The slot includes a vertical opening at one end which is configured to align with the guiding surface 1116 of the mobile member 1110. The retaining surface 1209 assists in retaining a tool 1300 during thermal disinfection.

The first body 1201 also assists in supporting the adjusting device 1210. The adjusting device 1210 in this embodiment includes a first adjusting member 1211 and a second adjusting member 1212. The first and second adjusting members 1211, 1212 are threadingly connected together. As the first adjusting member 1211 is rotated, the position of a stop 1216 on the second adjusting member 1212 is adjusted relative to the thermostatic element 1220. As would be appreciated from the valve 10, the position of the stop 1216 relative to the thermostatic element 1220 sets the predetermined outlet temperature of the valve 1010.

With the above in mind, it is noted that limit members 1213 of the adjusting device 1210 are connected to the upper portion of the first adjusting member 1211. The limit members 1213 limit the amount of rotation for the first adjusting member 1211. That is, the limit members 1213 each include a tab. These tabs are offset from each other when the limit members 1213 are passed along the upper spline portion of the first adjusting member 1211. Accordingly, when the first adjusting member 1211 is rotated, its rotation is limited when either of the tabs of the limit members 1213 engage with the barrier 1208. The tab of the upper limit member 1213 is configured to limit the maximum temperature position of the valve 1010 to a safe range. The tab of the lower limit member 1213 is configured to control the maximum shut position of the valve 1010. The lower limit member 1213 is also placed on top of a spacer 1215 (see FIG. 9).

During normal operation of the valve 1010, the thermostatic element 1220 responds to changes in temperature and assists with moving the piston 1230. The piston 1230 is supported by the spring 1250. As the piston 1230 moves, the flow of fluid through inlets 1204, 1205 is adjusted in order to ensure that the predetermined outlet temperature is reached through the outlet 1206. In order to thermally disinfect the valve 1010, the tool 1300 is used, as outlined further below.

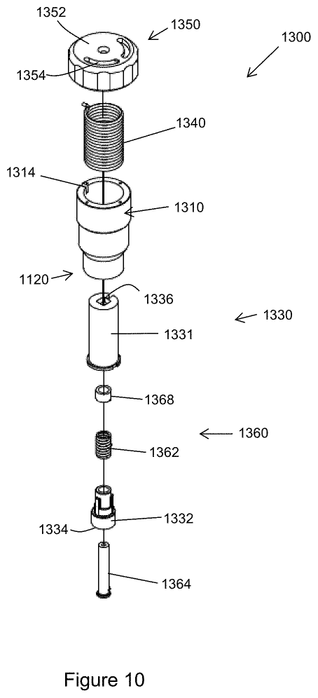

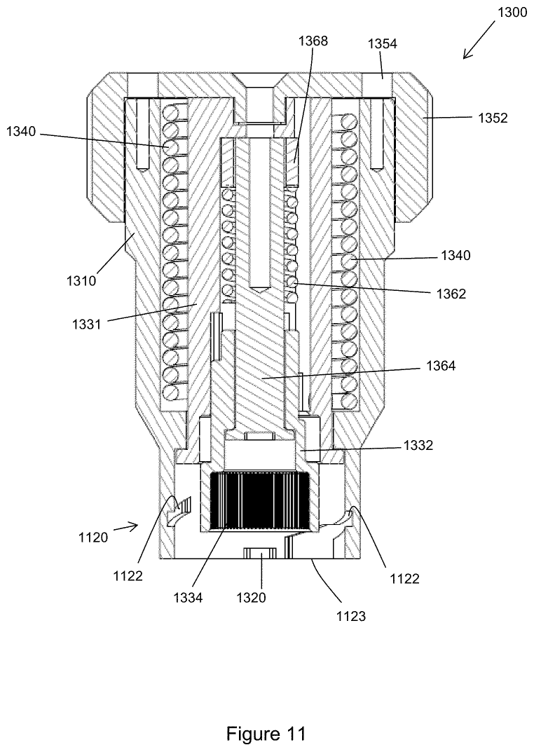

The tool 1300 includes an activation part 1310, as shown in FIGS. 10 and 11. The activation part 1310 includes an activation member in the form of tool activation member 1120. As shown further in FIG. 11, the tool activation member 1120 includes a tool camming surface 1122 on opposing sides of the activation part 1310. The tool camming surfaces 1122 extend in a helical manner. The tool camming surfaces 1122 also form an opening 1123 at a lower portion thereof.

In addition, the activation part 1310 includes an aperture 1314. The aperture 1314 is configured to receive part of a spring 1340. Furthermore, the activation part 1310 also includes a retaining part 1320 on opposing sides of the activation part 1310. The retaining parts 1320 are located adjacent to the tool camming surfaces 1123 on an inner portion of the activation part 1310. The retaining parts 1320 are in the form of tabs in this embodiment. The tabs extend substantially in a horizontal manner across the inner portion of the activation part 1310.

The tool 1300 also includes an engagement device 1330. The engagement device 1330 includes a supporting portion 1331 and an engagement portion 1332. The supporting portion 1331 includes a retaining portion 1336 configured to receive part of the spring 1340. The engagement portion 1332 engages with the supporting portion 1331 through one or more splines. In this regard, the engagement portion 1332 is unable to rotate with respect to the engagement portion 1332 but may translate in the axial direction. The engagement portion 1332 in this embodiment also includes a plurality of protrusion 1334 that are configured to engage with corresponding protrusions on the upper portion of the first adjusting member 1211.

A drive member 1350 is located above the activation part 1310 and the engagement device 1330. The drive member 1350 includes a handgrip 1352. A non-circular interface is provided between the handgrip 1352 and the supporting portion 1331 in order to allow a rotational force to be passed from the handgrip 1352 into the supporting portion 1331. A movement guide 1354 is also included in the handgrip 1352 to assist with limiting its rotation. A fastener (not shown) extends through the handgrip 1352 and engagement device 1330 into part of a balancing device 1360.

The balancing device 1360 in this embodiment includes a spring 1362 to bias the engagement portion 1332 towards one end of the shaft 1364. The engagement portion 1332 is retained on the shaft 1364 via a flange at one end. Furthermore, the shaft 1364 extends through the spring 1362 to retain the spring 1362. A spacer 1368 is located above the spring 1362. The size of the spacer 1368 may be changed to assists in achieving a suitable compression/force balance on the spring 1362. In further embodiments, once the ideal force balance on the spring 1362 has been determined, it would be appreciated that, for example, the internal geometry of the supporting portion 1331 may be designed to achieve the desired force balance on the spring 1362.

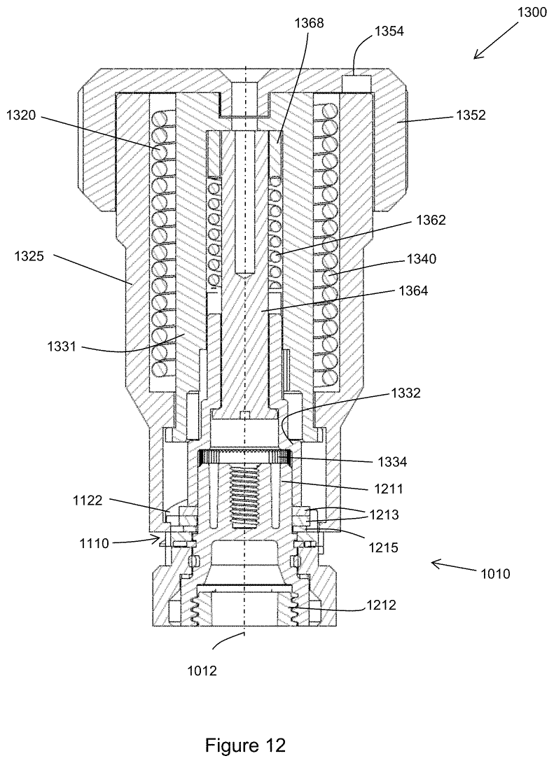

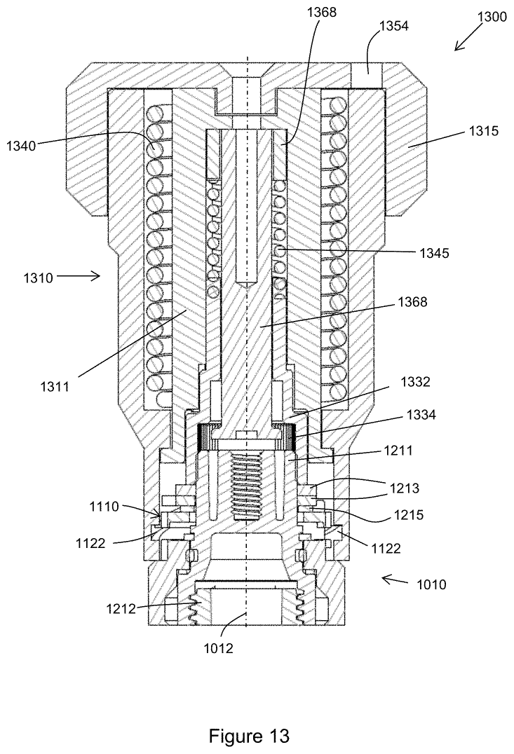

Activating the disinfection device 1100 of the valve 1010 is shown further in FIGS. 12 and 13. Firstly, the engagement portion 1332 of the tool 1300 is moved over the corresponding protrusions (i.e. splines) of the upper portion of the first adjusting member 1211. Following this, the tool 1300 is positioned (and potentially rotated) to allow the camming surfaces 1114 to move through their respective openings 1123 and engage with the tool camming surfaces 1122. Similarly, the retaining part 1320 moves though the guiding surface 1116 to engage with the retaining surface 1209.

Subsequently, the drive member 1350 is rotated about the axis 1012. This in turn rotates the tool activation member 1120 causing the tool camming surfaces 1122 to slide along the camming surfaces 1114 of the mobile member 1110. As the tool camming surfaces 1122 extends in a helical manner, the mobile member 1110 moves in the axial direction along the axis 1012 as the tool camming surfaces 1122 slide along the camming surfaces 1114. The movement of the mobile member 1110 in the axial direction results in a force being applied to lift the limit members 1213, via the spacer 1215, in the axial direction. The limit members 1213 are lifted to a point where at least the upper limit member 1213 is above the barrier 1208. This is evident in FIG. 13. In this position, the first adjusting member 1211 may be further rotated as the upper limit member 1213 will avoid the barrier 1208.

As the upper limit member 1213 is lifted above the barrier 1208, the retaining part 1320 reaches an end of the retaining surface 1209. When the retaining part 1320 is at the end of the retaining surface 1209, and the upper limit member 1213 is above the barrier 1208, further rotation of the driving member 1350 results in the engagement device 1330 being turned. That is, as the activation part 1310 is further prevented from rotating due to the engagement between the retaining part 1320 and the end of the retaining surface 1209, and at least the upper limit member 1213 cannot prevent rotation of the first adjusting member 1211, the driving member 1350 is able to rotate the engagement device 1330 and, as such, the first adjusting member 1211. Accordingly, the adjusting member 1211 can be rotated to a position that results in the stop 1216 moving further away from the thermostatic element 1220, putting the valve 1010 into a thermal disinfection state.

Once the thermal disinfection has taken place, the operator may release the torque they are applying through the handgrip 1352. As the spring 1340 has been torqued between the activation part 1310 and the engagement device 1330 during thermal disinfection, the spring 1340 biases the activation part 1310 and the engagement device 1330 back to their initial position before thermal disinfection. This returns the first and second adjusting member 1211, 1212 back to their initial position, along with the limit members 1213, to ensure that the predetermined outlet temperature is restored. Following this, the tool 1300 can be removed from the valve 1010.

With the above in mind, it is noted that the spring 1362 biases the engagement portion 1332 to maintain a force on the upper limit member 1213. This force assists in ensuring that the limit members 1213 return to their initial position after the tool 1300 is removed from the valve 1010. Also, the force from spring 1362 assists with keeping the limiting members 1213 and the mobile member 1110 aligned correctly during movement.

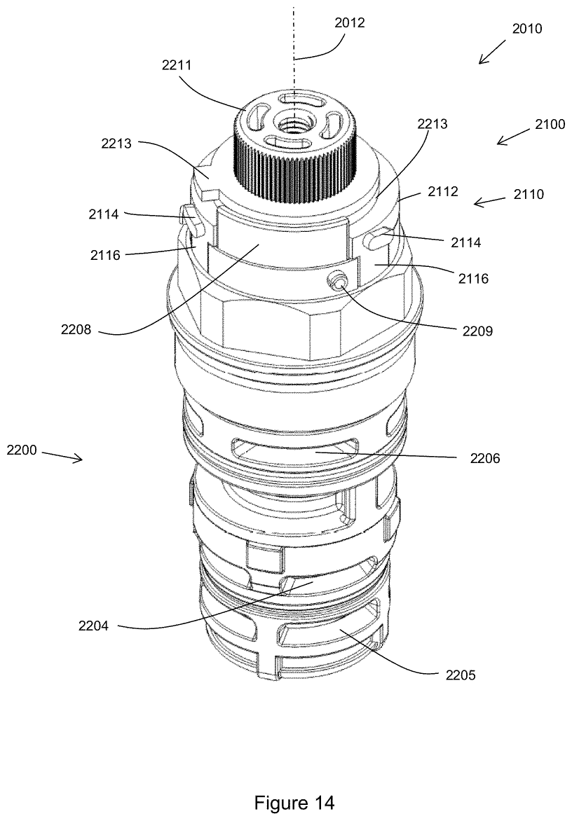

FIG. 14 illustrates a perspective view of a valve 2010, according to a further embodiment of the invention. In a similar manner to valve 1010, it will be appreciated that valve 2010 is in the form of a thermostatic cartridge. The valves 1010, 2010 include similar features therebetween. By way of example, the internals of the valve 2010 (not shown) are substantially similar to the valve 1010. Furthermore, the valve 2010 includes a disinfection device 2100 having a mobile member 2110 and a body 2200 having a first inlet 2204, second inlet 2205 and outlet 2206. Moreover, the valve 2010 includes a similar adjusting device 2210 having a first adjusting member 2211 and limit members 2213 that are configured to engage with barrier 2208. However, differences between the valve 1010 and the valve 2010 are discussed below.

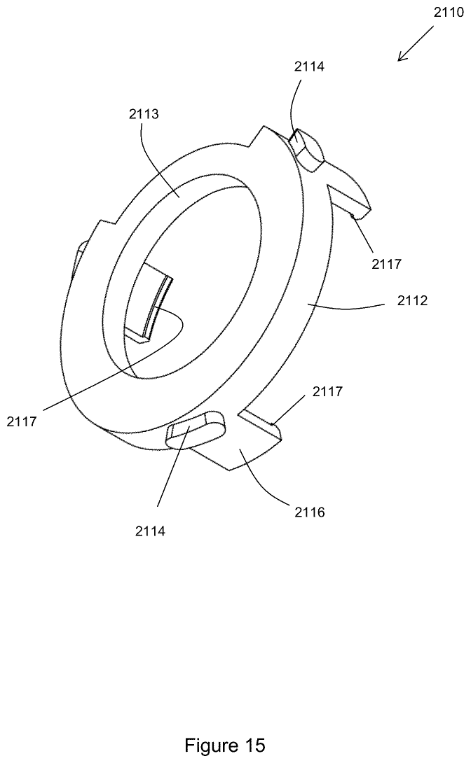

As can be seen in FIGS. 14 and 15, the mobile member 2110 of the valve 2010 includes an outer portion 2112 having camming surfaces 2114 that are different to camming surfaces 1114. In particular, the camming surfaces 2114 are included in an oval track shaped portion that extends away from the inner portion 2113. The mobile member 2110 also includes retaining portions 2116 in the form of legs that extend below the camming surfaces 2114. Each retaining portion 2116 includes a retaining ledge 2117. In response to the mobile member 2110 being lifted to a predetermined point, the retaining ledges 2117 are configured to engage with the body 2200 to prevent the mobile member 2110 from being dislodged from the body 2200. In this regard, the retaining ledges 2117 assist in setting a travel limit for the mobile member 2110.

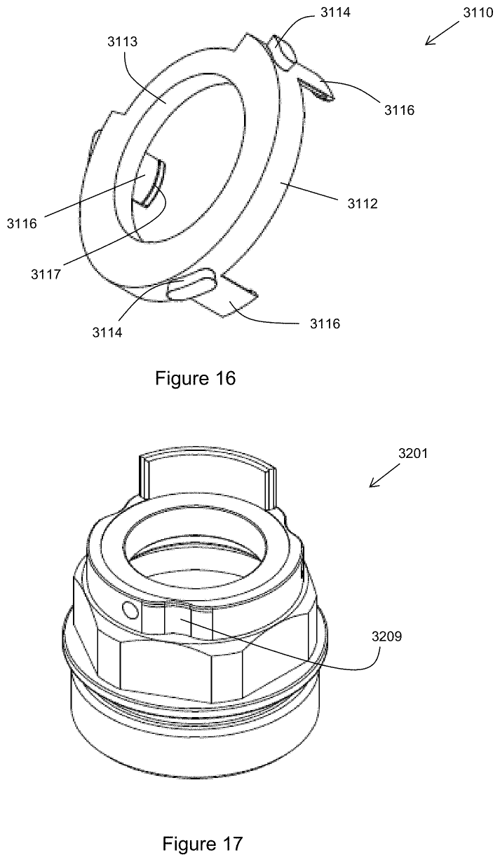

In a modified version of valve 2010, the mobile member 3110 may replace the mobile member 2110. The mobile member 3110 is shown in FIG. 16 and is substantially the same as mobile member 2110. That is, the mobile member 3100 includes an outer portion 3112 and an inner portion 3113. The camming surfaces 3114 are located on the outer portion 3112. Furthermore, the mobile member 3110 includes retaining portions 2116 in the form of legs. In contrast to the mobile member 2110, the mobile member 3100 includes retaining ledges 3117 that extend in a convex matter relative to the legs. The convex ledges 3117 assist with the manufacturing processes. With this in mind, the modified version of valve 2010 would also include a first body 3201, shown in FIG. 17. The first body 3201 includes an interacting surface 3209 that is configured to interact and retain the retaining portions 2116 when required. The interacting surface 3209 extends inwardly towards the axis 12 of the valve 2010.

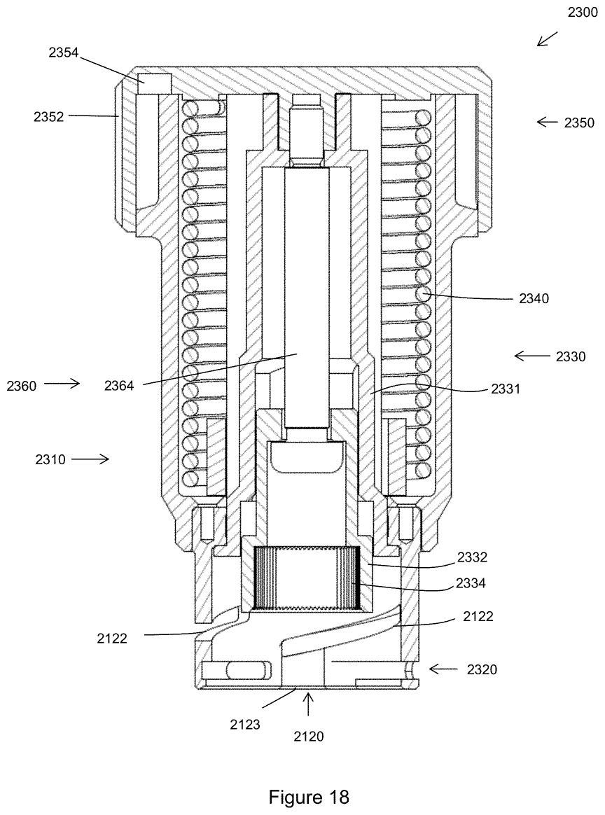

In addition, it is noted that the valve 2010 includes a retaining surface 2209 that extends away from a surface of the body 2200 (in comparison to being recessed into the body 1200). The retaining surface 2209 is in the form of a pin in this embodiment. In this regard, it will be appreciated that the tool that activates the mobile member 2110, in comparison to the retaining part 1320 of tool 1300, will include a recess that is configured to engage with the retaining surface 2209 to retain the tool thereon during thermal disinfection. The camming surfaces 2114 are activated in a similar manner to the engagement between the camming surface 1114 and the tool camming surfaces 1122. On this basis, it will also be appreciated that the tool used to assist in thermally disinfecting the valve 2010 will be substantially the same as tool 1300 with differences in the retaining part noted above, along with minor potential changes to the tool camming surfaces. To further illustrate these changes, tool 2300 is shown in FIG. 18. Tool 2300 is configured to activate the valve 2010. Tool 2300 includes a tool activation member 2120 having a tool camming surfaces 2122 and an opening 2123. The activation part 2310 assists in rotating the tool camming surfaces 2122. Furthermore, the retaining part 2320 assists in retaining the retaining surfaces 2209. The integer list below further illustrates other parts of the tool 2300. In this regard, it is noted that the spring of the balancing device 2360 has been omitted for ease of reference.

The present invention provides the ability to temporarily disable the operation of the valve 10, 1010, 2010 to allow it and its plumbing system downstream to undergo localised disinfection by passing hot water therethrough. This minimises the risk of bacterial growth. Separately, due to the spring 340, 1340, 2340 in the tool 300, 1300, 2300 the operator is unable to leave the thermal disinfection process unattended, which minimises the risk of accidentally leaving the thermal disinfection process on when people are using the water downstream. Furthermore, the valve 10, 1010, 2010 is readily returned to its predetermined outlet temperature after it has been thermally disinfected, adding convenience and further safety.

The disinfection device 100, 1100, 2010 may also be retrofitted to other suitable valves, in addition to valves 10, 1010, 2010, to provide a thermal disinfection feature. In this regard, the disinfection device 100, 1100, 2100 is flexible in its application and provides other commercial advantages.

In addition, compared to alternative disinfection methods, the disinfection device 100, 1100, 2100 does not include any additional seals from the internals of the valve. This is beneficial as no additional leak paths are introduced. Furthermore, the components of the disinfection device 100, 1100, 2100 can be made out of materials without potable water approvals. This allows materials with superior mechanical properties to be selected at a lower price, adding further commercial advantages.

In this specification, adjectives such as left and right, top and bottom, first and second, and the like may be used to distinguish one element or action from another element or action without necessarily requiring or implying any actual such relationship or order. Where context permits, reference to a component, an integer or step (or the like) is not to be construed as being limited to only one of that component, integer, or step, but rather could be one or more of that component, integer or step.

The above description relating to embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art from the above teaching. Accordingly, while some alternative embodiments have been discussed specifically, other embodiments will be apparent or relatively easily developed by those of ordinary skill in the art. The invention is intended to embrace all modifications, alternatives, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may include other elements not listed.

### Integer List:

| Embodiment #1 | Embodiment #2 | Embodiment #3 |
|---|---|---|
| Valve - 10 | Valve - 1010 | Valve - 2010 |
| Axis - 12 | Axis - 1012 | Axis - 2012 |
| Disinfection device - 100 | Disinfection device - 1100 | Disinfection device - 2100 |
| Mobile member - 110 | Mobile member - 1110 | Mobile member - 2110 |
| Outer portion - 112 | Outer portion - 1112 | Outer portion - 2112 |
| Inner portion - 113 | Inner portion - 1113 | Inner portion - 2113 |
| Camming surface - 114 | Camming surface - 1114 | Camming surface - 2114 |
| Retaining surface - 116 | Guiding surface - 1116 | Retaining portion - 2116 |
| Fastening portion - 118 | Tool activation member - 1120 | Retaining ledge - 2117 |
| Guiding members - 119 | Tool camming surface - 1122 | Mobile member - 3110 |
| Device activation member - 120 | Opening - 1123 | Outer portion - 3112 |
| Device camming surface - 122 | Body - 1200 | Inner portion - 3113 |
| Interface portion - 124 | First body - 1201 | Camming surface - 3114 |
| Recess portion - 126 | Second body - 1202 | Retaining portion - 3116 |
| Support member - 130 | Third body - 1203 | Retaining ledge - 3117 |
| Interfacing portion - 132 | First inlet - 1204 | Tool activation member - 2120 |
| Thread - 134 | Second inlet - 1205 | Tool camming surface - 2122 |
| Groove - 136 | Outlet - 1206 | Opening - 2123 |
| Sealing member - 140 | Barrier - 1208 | Body - 2200 |
| Sealing member - 142 | Retaining surface - 1209 | First inlet - 2204 |
| Split pin - 150 | Adjusting device - 1210 | Second inlet - 2205 |
| Body - 200 | First adjusting member - 1211 | Outlet - 2206 |
| Cap - 201 | Second adjusting member - 1212 | Barrier - 2208 |
| Main body - 202 | Limit member - 1213 | Retaining surface - 2209 |
| First inlet - 204 | Spacer - 1215 | First body - 3201 |
| Second inlet - 206 | Stop - 1216 | Interacting surface - 3209 |
| Outlet - 208 | Thermostatic element - 1220 | Adjusting device - 2210 |
| Adjusting device - 210 | Piston - 1230 | First adjusting member - 2211 |
| Spindle - 212 | Spring - 1250 | Limit member - 2213 |
| Spring -214 | Tool - 1300 | Tool - 2300 |
| Stop - 216 | Activation part - 1310 | Activation part - 2310 |
| Circlip - 218 | Aperture - 1314 | Retaining part - 2320 |
| Thermostatic element - 220 | Retaining part - 1320 | Engagement device - 2330 |
| Piston - 230 | Engagement device - 1330 | Supporting portion - 2331 |
| Separator - 240 | Supporting portion - 1331 | Engagement portion - 2332 |
| Seat - 242 | Engagement portion - 1332 | Protrusion - 2334 |
| Further spring - 250 | Protrusion - 1334 | Spring - 2340 |
| Tool - 300 | Retaining portion - 1336 | Driving member - 2350 |
| Activation part - 310 | Spring - 1340 | Handgrip - 2352 |
| Protrusions - 312 | Driving member - 1350 | Movement guide - 2354 |
| Aperture - 314 | Handgrip - 1352 | Balancing device - 2360 |
| Retaining part - 320 | Movement guide - 1354 | Shaft - 2364 |
| Engagement device - 330 | Balancing device - 1360 | |
| Engagement portion - 332 | Spring - 1362 | |
| Protrusions - 334 | Shaft - 1364 | |
| Retaining portion - 336 | Spacer - 1368 | |
| Hole - 338 | | |
| Spring - 340 | | |
| Driving member - 350 | | |
| Handgrip - 352 | | |
| Movement guide - 354 | | |
| Guiding member - 356 | | |
| Fastener - 358 | | |
| Balancing device - 360 | | |
| Spring - 362 | | |
| Shaft - 364 | | |
| Balancing member - 366 | | |
| Spacer - 368 | | |
| Holding device - 370 | | |
| Holding member - 372 | | |
| Nut - 374 | | |
| Thread - 376 | | |

1-20. (canceled)

21. A disinfection device for a valve, the disinfection device including:
a mobile member having an outer portion including a camming surface configured to engage with an activation member such that rotation of the activation member relative to the camming surface, about an axis, moves the mobile member in the axial direction,
wherein:
the mobile member is associated with an adjusting device of the valve such that movement of the mobile member in the axial direction moves at least part of the adjusting device to allow adjustment of a predetermined outlet temperature of the valve; and
the mobile member is operable by application of a tool that cannot be removed from the disinfection device whilst the predetermined outlet temperature of the valve is adjusted.

22. The disinfection device of claim 21, wherein the camming surface extends in a diagonal manner around at least part of the mobile member.

23. The disinfection device of claim 21, wherein an outer portion of the mobile member includes a retaining surface to assist in retaining a part of the tool.

24. The disinfection device of claim 21, wherein the tool is configured to move between a first position and a second position where the valve undergoes thermal disinfection, the tool being able to be removed from the disinfection device upon returning to the first position.

25. The disinfection device of claim 21, wherein the mobile member includes an inner portion that is configured to receive at least an upper portion of the adjusting device.

26. The disinfection device of claim 21, wherein the disinfection device includes a support member configured to engage with a body of the valve.

27. The disinfection device of claim 21, wherein the mobile member is configured to be threadably connected to the adjusting device.

28. A tool for operating the disinfection device of claim 21, the tool including:
an activation part configured to assist in rotating a camming surface of the activation member in order to move the mobile member of the disinfection device; and
a retaining part having a retaining surface configured to assist in preventing the tool from being removed from the disinfection device whilst the predetermined outlet temperature of the valve is adjusted.

29. A valve including:
a body with two or more inlets and an outlet;
an adjusting device associated with the body, the adjusting device providing a stop;
a thermostatic element being configured to assist with moving a piston connected thereto in response to engaging with the stop, the piston being configured to regulate the flow of fluid between the inlets and the outlet; and
a disinfection device of claim 21.

30. The valve of claim 29, wherein a connection between the adjusting device and the mobile member sets a position of the stop, relative to the thermostatic element, which determines the predetermined outlet temperature.

31. The valve of claim 29, wherein the adjusting device includes a thread to set the predetermined outlet temperature of the valve.

32. The valve of claim 29, wherein the mobile member is releasably connected to the adjusting device.

33. The valve of claim 29, wherein the adjusting device includes a limit member to limit rotation thereof.

34. The valve of claim 29, wherein the adjusting device includes a housing in the form of a spindle that is substantially hollow with one closed end.

35. The valve of claim 34, wherein the adjusting device includes a spring that is located in the hollow of the spindle.

36. The valve of claim 35, wherein the spring biases the stop towards an open end of the spindle.

37. A method of operating a disinfection device for a valve, the method including the steps of:
engaging an engagement device of a tool with at least part of the disinfection device; and
rotating an activation member about an axis with the assistance of a drive member, the activation member being engaged with a mobile member such that rotation of the activation member moves the mobile member in the axial direction,
wherein:
the mobile member is associated with an adjusting device of the valve such that movement of the mobile member moves at least part of the adjusting device to allow adjustment of a predetermined outlet temperature of the valve; and
the tool that cannot be removed from the disinfection device whilst the predetermined outlet temperature of the valve is adjusted.

38. The method of claim 37, wherein the step of engaging the engagement device of the tool with at least part of the disinfection device includes aligning a camming surface of the tool with a camming surface of the mobile member.

39. The method of claim 37, wherein the step of engaging the engagement device of the tool with at least part of the disinfection device includes engaging one or more protrusions of the tool with at least part of the valve.

40. The method of claim 37, wherein the step of rotating the activation member about the axis includes biasing a spring in order to return the tool to an initial position when the tool is released.
